(19) United States
(12) Patent Application Publication
(10) Pub. No.: US 2014/0160115 A1
(43) Pub. Date: Jun. 12, 2014

(54) System And Method For Visually Displaying Information On Real Objects

(71) Applicants: Peter Keitler, Muenchen (DE); Bjoern Schwerdtfeger, Muenchen (DE); Nicolas Heuser, Muenchen (DE); Beatriz Jimenez-Frieden, Deisenhofen (DE)

(72) Inventors: Peter Keitler, Muenchen (DE); Bjoern Schwerdtfeger, Muenchen (DE); Nicolas Heuser, Muenchen (DE); Beatriz Jimenez-Frieden, Deisenhofen (DE)

(21) Appl. No.: 14/009,531

(22) PCT Filed: Apr. 2, 2012
(86) PCT No.: PCT/EP12/01459

§ 371 Date: Dec. 6, 2013

(30) Foreign Application Priority Data
Apr. 4, 2011 (DE) 10-2011-015987.8

(51) Int. Cl. G06T 19/00; G06T 7/00

(52) U.S. Cl. CPC G06T 19/006; G06T 7/004
USPC 345/419; 345/633

(57) ABSTRACT

A system for visually displaying information on real objects has a projection unit that graphically or pictorially transmits an item of information to an object, and a dynamic tracking device with a 3D sensor system that determines and keeps track of the position and/or orientation of the object and/or of the projection unit in space. A control device adapts the transmission of the item of information to the current position and/or orientation of the object and/or of the projection unit as determined by the tracking device. An associated for the system determines the current position and/or orientation of the object and/or of the projection unit in space, graphically or pictorially transmits an item of information to the object on the basis of the position and/or orientation as determined, detects and determines any changes, and adapts the transmission of the item of information to the changed position and/or orientation.

### RELATED APPLICATION

This is the U.S. national phase of PCT/EP2012/001459, filed Apr. 2, 2012, claiming priority to DE 10 2011 015 987.8, filed on Apr. 4, 2011.

### TECHNICAL FIELD

The present invention relates to a system for visually displaying information on real objects. The present invention further relates to a method of visually displaying information on real objects.

### BACKGROUND

Various augmented reality systems (in short: AR systems) are known, by means of which, in general, perception of visual reality is extended. For example, images or videos can be supplemented by insertion of computer-generated additional information. But information that is visible to an observer can also be transmitted to real objects. This technology is made use of in design, assembly or maintenance, among other fields. In this way, laser projectors or video projectors may provide an optical assistance, such as when aligning large stencils for varnishing or in quality assurance. For a precise projection, however, the projector until now had to be statically mounted at one place. The workpieces each had to be precisely calibrated, depending on the position and orientation (pose) of the projector. Each change in the pose of the projector or of the workpiece required a time-consuming renewed calibration. Therefore, until now, projection systems can be usefully employed only in static structures.

It is the object of the invention to extend the fields of application of a system for visually displaying information on real objects.

### SUMMARY

A system for visually displaying information on real objects includes a projection unit that graphically or pictorially transmits an item of information to an object and a dynamic tracking device having a 3D sensor system that determines and keeps track of the position and/or orientation of the object and/or of the projection unit in space. A control device for the projection unit adapts the transmission of the item of information to the current position and/or orientation of the object and/or of the projection unit as determined by the tracking device.

The system allows the efficiency of manual work steps in manufacture, assembly, and maintenance to be enhanced and, at the same time, the quality of work to be improved. The precise transmission of information, for example the digital planning status (CAD model) directly to a workpiece, makes the complex and error-prone transmission of construction plans by using templates and other measuring instruments dispensable. A visual variance comparison can be performed at any time and intuitively for a user. In addition, work instructions, e.g., step-by-step guidance, can be made available directly at the work object or in the field of view of the user, that is, exactly where they are actually needed.

The combination of a projector with a dynamic 3D tracking device allows a continuous, automatic calibration (dynamic referencing) of the projector and/or of the object on which an item of information is to be displayed, relative to the work environment. As a result, both the projection unit and the object may be moved freely since upon each movement of the projection unit or of the object the graphical and/or pictorial transmission of the information is automatically tracked. Thanks to this mobility, in contrast to the known, static systems, the subject system automatically adapts to different varying environmental conditions. This opens up a much wider spectrum of possible applications.

For example, in large and/or unclear environments as are prevailing in aircraft construction or shipbuilding, for instance, the system can always be positioned such that the parts to be processed of a workpiece are situated in the projection area. In addition, the flexible placement allows disturbances from activities going on in parallel to be avoided to the greatest possible extent. Also, in scenarios in which an object is moved during the work process, such as on a conveyor belt, it is possible to project assembly instructions or information relating to quality assurance directly onto the object, with the projection moving along with the movement of the object.

Typical scenarios of application of the invention include workmen's assistance systems for displaying assembly and maintenance instructions and information for quality assurance. For example, assembly positions or boreholes can be precisely marked or weld spots or holders to be checked can be identified. The system is also suitable to provide assistance to on-site servicing staff by non-resident experts who can remote control the projection by an integrated camera.

In order to avoid any delay in the transmission of the projected information to the object, which may lead to errors or inaccuracies during operations, the dynamic tracking device is designed for a continuous detection of the position and/or orientation of the object and/or of the projection unit in real time.

The projection unit is the core of the visualization system. A flexibility, not available in conventional systems, is achieved in that the projection unit is an apparatus for mobile installation, in which a projector, preferably a laser projector or video projector and, at the same time, the 3D sensor system of the tracking device are accommodated. What is important here is a rigid connection between the projector and the receiving unit of the 3D sensor system (camera or the like), in order to maintain a constant, calibratable offset. This allows the position and/or orientation of the projection unit to be precisely determined at any time, even if the projection unit is repositioned in the meantime.

In comparison with other projection techniques, a laser projector is very high-contrast and ensures the best possible visibility of contours and geometries, even on dark or reflective surfaces and also in bright environments (daylight). Further advantages of a laser projector include the long useful life of the light source and the low power consumption as well as the ruggedness under adverse conditions.

A further preferred variant is the employment of a video projector. While both its maximum resolution and its contrast are markedly lower than those of a laser projector, it offers the advantage of a full-color representation across an area, whereas use of a laser projector only allows a few contours to be represented at the same time and in only one color or few colors. All in all, a video projector is able to display considerably more information at the same time.

According to one example embodiment, the 3D sensor system of the tracking device includes at least one camera which is preferably firmly connected with a projector of the projection unit. Cameras are very well-suited for tracking applications. In conjunction with specific markers which can be detected by a camera, the pose of the camera can be inferred by means of mathematical methods. Now if the camera, as a part of the 3D sensor system of the tracking device, is accommodated in the projection unit (i.e. if a rigid connection is provided between the camera and the projector), the pose of the projector can be easily determined.

For calibration and/or keeping track of the projection unit and/or of the object, special markers are useful which are arranged at reference points of an environment in which the system is employed, and which are adapted to be detected by the 3D sensor system of the tracking device.

According to a particularly advantageous aspect of the invention, the markers and the tracking device are adjusted to each other such that by using the markers, the tracking device can, on the one hand, perform a calibration of the reference points in a coordinate system of the environment or of the object and, on the other hand, can perform the determination and keeping track of the position and/or orientation of the object and/or of the projection unit. That is, in this case the markers fulfill a dual function, which reduces the expenditure for the preparations preceding the use of the visualization system and thus increases the efficiency of the system.

The markers may, more particularly, be based on flat markers and preferably include characteristic rectangles, circles and/or corners which may be made use of to advantage for ascertaining the pose of the camera in relation to the markers.

For calibration and tracking it is advantageous if the markers include unique identification features adapted to be detected by the tracking device, in particular in the form of angular or round bit patterns.

In one example embodiment of the invention, the markers include retroreflector marks which are preferably arranged in the center of the respective marker. Using a laser projector, the retroreflector marks can be aimed at well and, using an optimization algorithm, a centering can be effected by measuring the reflected light, so that 2D correspondences in the image coordinate system of the projection unit matching with reference positions known in 3D can be produced for a calculation of the transformation between the projection unit and the object.

According to an advantageous configuration, the retroreflector marks are formed as spherical elements having an opening through which a retroreflector film is visible which is preferably fixed to the center of the sphere. A spherical element of this type may be rotated about its center as desired in order to obtain a better visibility, without this changing the coordinates of the center of the sphere with the retroreflector film.

Preferably, the markers are configured such that they are adapted to be fixed, in the environment in which the system is employed, to reference points having a known or reliable position in a coordinate system of the environment or of the object. In particular, the markers may be fitted into so-called RPS (reference point system) holes which in many applications are already provided at defined reference points and are particularly precisely known and documented in the coordinate system of the object. RPS holes are, for example, utilized by robots for grasping a component. Likewise, provision may be made for fitting them in holes of a (standardized) perforated plate with a fixed and known hole matrix as is frequently used in measuring technology, and/or on a surface of the object.

According to a special aspect, a marker may be fixed in place at several points in order to also define the orientation of the marker in space. This is of advantage to some special applications.

Optionally, also the entire markers may be configured such that they are adapted to be fixed, via adapters or intermediate pieces, to reference points having a known or reliable position (and, where appropriate, orientation) in a coordinate system of the environment or of the object, in particular by being fitted into RPS holes provided at the reference points. In this way, in the case of a flat marker, which may be supplemented by a retroreflector mark, the flat marker tracking may provide the pose of the flat marker, so that by way of the known geometry of the adapter or intermediate piece, the known pose of the standard bore in the reference point is transferable to the pose of the flat marker, and vice versa. In addition, provision may be made to fix the adapters or intermediate pieces in holes of a (standardized) perforated plate with a fixed and known hole matrix and/or on a surface of the object. The adapters and the markers are adjusted to each other such that the markers can be uniquely plugged into the adapters. Owing to the fixed correlation, a calibration of the adapters and the markers relative to each other is then not required. As a result, the markers may be produced in a generic shape, whereas the adapters can be better adapted to different scenarios. But, here too, the goal is to make do with as few adapters as possible. For this reason, the adapters are preferably fabricated such that they have standardized plug-in/clamping/magnetic mountings, to allow them to be employed on as many workpieces as possible.

A preferred design of the markers makes provision that the markers each include a standard bore and a magnet arranged under the standard bore. Ball-shaped retroreflector marks having a metallic base can then easily be fitted into the standard bore and are held by the magnet, an alignment of the retroreflector marks being possible by rotation.

The visualization system may also be realized entirely without markers. In this alternative embodiment, the projection unit and the tracking device are designed such that structured light scanning technology is made use of for determining the position and/or orientation of the object. The effort for the preparation of the object with markers is dispensed with here.

The invention also provides a method of visually displaying information on real objects using a projection unit. The method according to the invention includes the steps of:
determining the current position and/or orientation of the object and/or of the projection unit in space;
graphically or pictorially transmitting an item of information to the object on the basis of the position and/or orientation as determined;
detecting and determining a change in the position and/or orientation of the object and/or of the projection unit; and
adapting the transmission of the item of information to the changed position and/or orientation of the object and/or of the projection unit.

The advantages of this method correspond to those of the system according to the invention for visually displaying information on real objects.

For an instant and accurate tracking of the projected information upon a change in the position or orientation of the object and/or of the projection unit, provision is made that the current position and/or orientation of the object and/or of the projection unit is continuously detected in real time.

In an advantageous manner, a laser projector of the projection unit may be utilized to aim at markers which are arranged at reference points of an environment in which the method is employed, the markers being detected by a 3D sensor system of a tracking device.

In accordance with a particularly preferred embodiment of the method according to the invention, markers—preferably the same markers—are used for a calibration of the reference points in a coordinate system of the environment or of the object and for the determination of a change in the position and/or orientation of the object and/or of the projection unit.

In the method according to one example, it is possible to use an inside-out type tracking method using at least one movable camera and fixedly installed markers for the detection and determination of a change in the position and/or orientation of the object and/or of the projection unit. The camera may be accommodated within the mobile projection unit and is thus always moved together with the projector situated therein. For a reliable calibration of the offset between the projector and the camera, a rigid connection is provided between the two devices.

In another example, the method markers may be dispensed with entirely. For determining the position and/or orientation of the object, a structured light scanning process is carried out instead, in which preferably the projection unit projects an image which is captured using one or more cameras and is subsequently triangulated or reconstructed. Further preferably, points on the object are scanned in accordance with a predefined systematic process, and an iterative best fit strategy is utilized for calculating the position and/or orientation of the object.

### BRIEF DESCRIPTION OF THE DRAWINGS

Further and advantages of the invention will be apparent from the description below and from the accompanying drawings, to which reference is made and in which:

FIG. 1 shows a sectional view of a fuselage barrel of an aircraft with a system according to the invention;

FIG. 2 shows a detail magnification from FIG. 1;

FIG. 3 shows a detail magnification from FIG. 2 in the case of a correct mounting fitting;

FIG. 4 shows a detail magnification from FIG. 2 in the case of a faulty mounting fitting;

FIG. 5 shows a top view of a flat marker;

FIG. 6 shows a perspective view of a flat marker;

FIG. 7 shows a perspective view of a three-dimensional marker;

FIG. 8 shows a top view of a combination marker, with no retroreflector mark inserted yet;

FIG. 9 shows a side view of a combination marker, with no retroreflector mark inserted yet;

FIG. 10 shows a side view of a combination marker fitted in a work environment, but with no retroreflector mark inserted;

FIG. 11 shows a sectional view of a reference mark;

FIG. 12 shows a side view of a combination marker with a retroreflector mark and viewing angle ranges for laser projector and camera;

FIG. 13 shows a side view of a combination marker with the retroreflector mark inclined;

FIG. 14 shows a side view of a combination marker fitted in a work environment with the aid of an intermediate piece, without a retroreflector mark;

FIG. 15 shows a side view of a combination marker without a retroreflector mark with a plug-in adapter;

FIG. 16 shows a schematic illustration of the fastening of markers in RPS bores or holes of a perforated plate; and

FIG. 17 shows a bracket provided with markers in the sense of a virtual gauge.

### DETAILED DESCRIPTION

By way of example, an employment scenario for a system and a method for visually displaying information on real objects (visualization system) will be discussed below, more specifically checking the mounting fitting in constructing an aircraft.

The construction of large objects (aircraft, ships, manufacturing systems, machines, etc.) is still largely carried out by hand. For one thing, the small numbers of units do not justify an employment of robots; for another thing, the large dimensions make the objects difficult to handle by machines. Production is similar to a manufactory. Large objects, such as fuselage barrels in aircraft construction, stand statically at one place and are systematically equipped manually over a period of weeks. Therefore, quality assurance is of a central importance in order to be able to ensure a constant quality level.

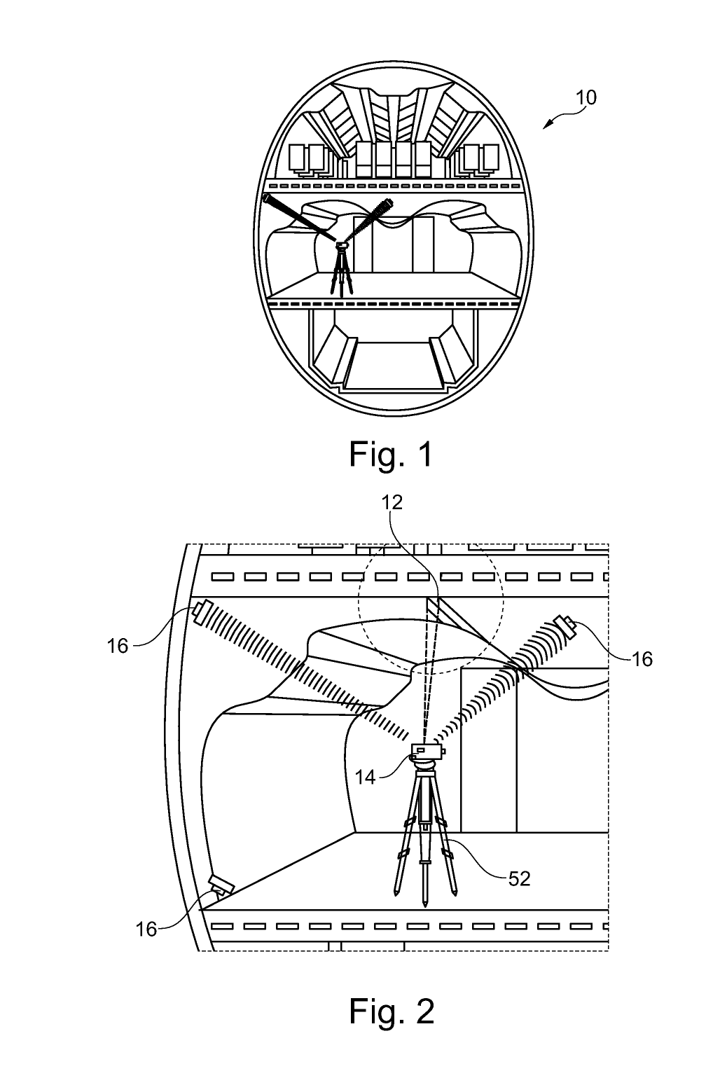

FIGS. 1 and 2 show the fuselage barrel 10 of a wide-bodied aircraft. It is about 12 m long and 8 m high. Such fuselage segments are first built up separately and joined together only later to form a fuselage. The fitting of mountings 12 for the later installation of on-board electronics, air-conditioning system etc. takes up a lot of time for each fuselage barrel 10. Quality assurance, i.e. the check of the correct fitting of a multitude of mountings 12, has a considerable share therein. It has, to date, been accomplished by a major employment of staff on the basis of large-sized construction plans which are generated from a CAD model and then printed out. The monotony of the work as well as frequent shifts of one's focus between the construction plan and the object lead to careless mistakes, not only in manufacturing, but also in quality assurance, which have an adverse effect on the productivity of subsequent work steps.

The check of the correct fitting of the mountings 12 in the fuselage barrel 10 can be accomplished according to the illustration in FIG. 1 with the aid of the visualization system which includes a mobile projection unit 14 for graphically or pictorially transmitting an item of information to an object (workpiece), preferably with a laser projector or video projector. The system further comprises a dynamic tracking device having a 3D sensor system for determining and keeping track of the position and/or orientation of the object and/or of the projection unit 14 in space. Finally, the system also comprises a control device for the projection unit 14 which adapts the transmission of the item of information to the current position and/or orientation of the object and/or of the projection unit 14 as determined by the tracking device. The laser projector or video projector, the 3D sensor system of the tracking device, and the control device are all accommodated within the mobile projection unit 14. The control device here should be understood to mean those components which provide for an adaptation of the projection, in particular with respect to direction, sharpness and/or size. An operating and supply installation (not shown) is connected to the projection unit 14 with a long and robust cable conduit (electricity, data).

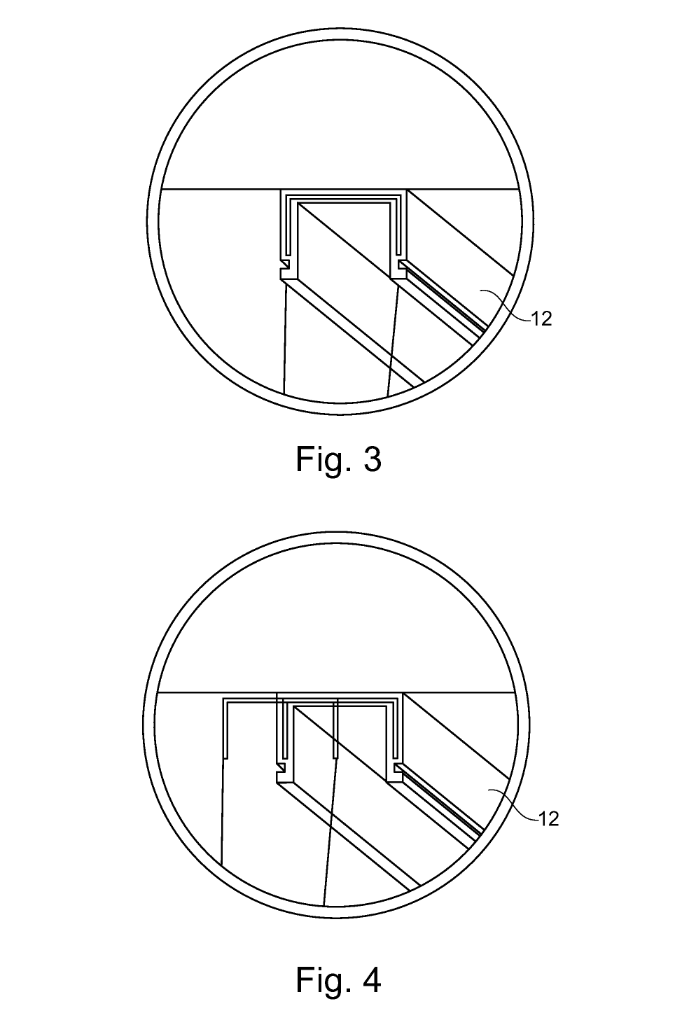

The information from the construction plans that is essential to the fitting of the mountings 12, in particular the arrangement and the contours of components, is available to the system. In particular, provision is made to export assemblies from a CAD model and to condition them for a projection in a largely automated manner. A polygonal chain (contour) is generated which can be reproduced by the laser projector or video projector. Using the projection unit 14, this allows the desired information to be projected onto the already installed object in accordance with the specification from the CAD model. On the basis of the projection, any discrepancies with the construction plans will be directly apparent. FIG. 3 shows a correct fitting of a mounting 12; FIG. 4 shows a faulty fitting. In addition or alternatively to the pure CAD data, further references, step-by-step instructions, arrows etc. may also be projected. In this way, careless mistakes are largely ruled out, and the check of the fitting can be performed considerably faster. Due to the assistance provided by the visualization system, it is basically possible to carry out the manufacture and quality assurance in combination, for a further increase in productivity.

A basic requirement for the correct functioning of the visualization system is that the position and/or orientation (depending on the application) of the projection unit 14 in the work environment can be determined with the 3D sensor system at any point in time. To this end, provision is made that the calibration that is required for the determination of the position and/or orientation is effected dynamically, i.e. not just once, but continuously or at least after each automatically detected or manually communicated change in position and/or orientation, with the tracking device via standardized reference points (dynamic referencing). These reference points may be temporarily fitted to various spatial positions in a simple fashion, e.g. by using an adhesive tape and/or hot-melt adhesive, for example.

According to a first variant, the reference points can be precisely measured using a commercially available laser tracker, with the coordinate system of the work environment, in this case the aircraft coordinate system, being taken as a basis.

According to a second, preferred variant, special markers 16 adjusted to the 3D sensor system of the tracking device are hooked in at the reference points. The special requirements made on the markers 16 will be discussed in detail further below. At any rate, the 3D sensor system can calibrate the reference points by using the markers 16 and subsequently calibrate the projection unit 14 into the coordinate system of the work environment. The visualization system is then ready for operation.

In the above-described application in aircraft construction, the markers 16 are glued on and calibrated and are then available for the whole duration of a phase of construction (several weeks), i.e. until such time as the current positions are covered up because of the construction progress; the markers 16 would then have to be refitted if required. This allows further work steps within a phase of construction to be converted to the use of the visualization system with the projection unit 14 without any additional effort (calibration of the reference points).

For the dynamic calibration (referencing) of the projection unit 14 and its seamless integration into existing work processes, the basic technologies of “classical metrology” and “tracking” are combined. Classical metrology is an industry standard. While it is very precise, it is expensive and inflexible since it always requires two separate work steps, more specifically the measurement proper and the editing/visualization/analysis of the measured data.

In contrast to classical metrology, tracking designates real-time measuring systems. Typically, the position and orientation (pose, six degrees of freedom) are determined. An essential advantage resides in that owing to the real-time nature of the measurement, the results are immediately available. Any complicated later evaluation of measured data is dispensed with. In addition, tracking is a basic requirement for augmented reality systems (AR systems) for interactive insertion of virtual contents (CAD data etc.) into the field of view of the user, such systems also including the visualization system described above.

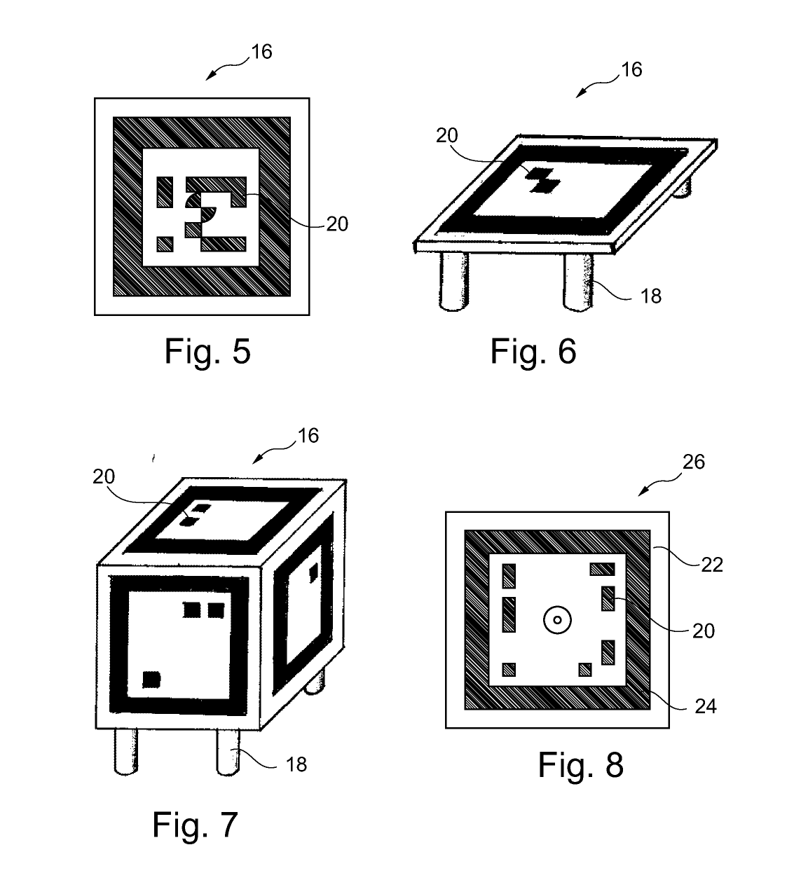

The markers 16, which are used both for the calibration of the reference points and for the dynamic referencing of the projection unit 14, will now be discussed in greater detail below. For an optical tracking using a camera, so-called flat markers are suitable, which can be produced in any desired size. An example of such a flat marker having a bit pattern 20 is shown in FIG. 5. Applying mathematical methods, the pose of the camera relative to the marker 16 can be established by outer and inner rectangles 22 and 24, respectively (corner points). A simple, inexpensive camera is basically sufficient for this purpose; several and/or higher-quality cameras will increase precision.

FIG. 6 shows a flat marker having three legs 18, so that provision of a corresponding seat will ensure a unique orientation of the marker 16. FIG. 7 shows a three-dimensional marker 16 in the form of a cuboid, more precisely a cube the sides of which have bit patterns 20 assigned to them.

The integration of tracking methods into existing processes generally turns out to be difficult, above all because of the problems presented by calibration, which have not, to date, been solved and which will be briefly explained below. Those few systems that are in productive use are exclusively based on so-called “outside-in methods”, in which sensors (in particular cameras) are firmly installed in the environment and permanently calibrated therein. This is inflexible and can be actually implemented in only very few of the potential application scenarios for AR systems since either the environment cannot be permanently equipped with cameras (e.g. an aircraft or ship under construction) or visual obstructions occur in the work process which would require a flexible alignment of the cameras (e.g., staff, building material, partition walls, work platforms, etc.). In addition, in many cases outside-in systems suffer from insufficient rotational accuracy.

Generally, in measuring technology the guiding principle applies that the volume of the points used for calibration should roughly correspond to the measuring volume. In outside-in tracking it is necessary for a plurality of reference points fitted to the mobile system to be recognized “from outside” and used for referencing. However, since the visualization system is mobile and therefore limited in its size, the guiding principle can be taken account of only insufficiently. Moreover, a faulty recognition of the orientation of the projection unit has the effect that the projection on the workpiece is subject to a positional inaccuracy which increases linearly with the working distance.

So-called “inside-out systems”, in which the cameras are moved which “track” markers that are firmly installed in the environment, have so far been used only in research. Their productive use is factually prevented by the problems involved in calibration, which have not, to date, been solved.

The visualization system now uses an inside-out type measuring method and combines it with a real-time tracking method to achieve more flexibility and interactivity within the meaning of an AR application. In this way, a cloud of reference points which “encompasses” the measuring volume considerably better, can be utilized in any situation. Ideally, the projection unit 14 has a plurality of cameras arranged therein as part of the 3D sensor system, e.g. as a stereo system, or in a situation-dependent manner also with cameras directed upward/downward/rearward. But even with just one camera, the problem as described above of the projection error increasing linearly with the increase in the working distance does no longer exist. Although in the worst case, the detection of the position and/or orientation of the mobile projection unit 14 is subject to an error, the fact that the markers are situated on the projection surface allows the markers and the holders located in between to be always exactly aimed at by the laser projector, even if there is a small error in the position or orientation of the unit.

For the calibration of the projection unit into the underlying coordinate system of the object, so-called retroreflector marks are suitable, which reflect most of the impinging radiation in a direction back to the source of radiation, largely irrespectively of the orientation of the reflector. The retroreflector marks may be, e.g., spherical elements having an opening through which a retroreflector film is visible which is fixed to the center of the sphere. Such retroreflector marks are usually fitted into standard bores in the object (workpiece), possibly by using special adapters. The mobile projection unit 14 can then calibrate itself semi-automatically into the environment by way of the laser beam and a special sensor system. In the process, the retroreflector marks are manually roughly aimed at with crosshairs projected onto the workpiece by the laser projector. The bearing of the laser projector measures azimuth and elevation angles, that is, 2D points on its imaginary image plane (comparable to a classical tachymeter). An optimization algorithm automatically centers the crosshairs by measuring the reflected light and thus supplies a 2D correspondence in the image coordinate system of the projection unit 14, matching the reference position known in 3D. On the basis of at least four 2D-3D correspondences, the transformation between the projection unit 14 and the object can be calculated. This calibration process has to be carried out again upon each setup or alteration of the projection unit 14. But the method is very accurate. If the transformation between the workpiece and the projection unit 14 is still approximately valid (e.g. after a vibration or a slight shock), a renewed, high-precision aiming at the retroreflector marks can be carried out fully automatically. In principle, this method is analogous with a manual calibration, but the bearing using the crosshairs is dispensed with. In this way, optimized 2D coordinates can be measured for all existing retroreflector marks in about 1 to 3 seconds (depending on the number of markers) and the transformation can be adapted accordingly. Therefore, a validation can also be effected at any time as to whether the current transformation still meets the accuracy requirements.

For an improved automated calibration of the reference points and a tracking using a camera, so-called combination markers are suitable. A combination marker is based on a conventional flat marker having a bit pattern, as is shown by way of example in FIGS. 5 to 7, and is extended by a retroreflector mark. The retroreflector mark is fixed directly in the center of the flat marker, so that both methods can uniquely identify the same center of the combination marker.

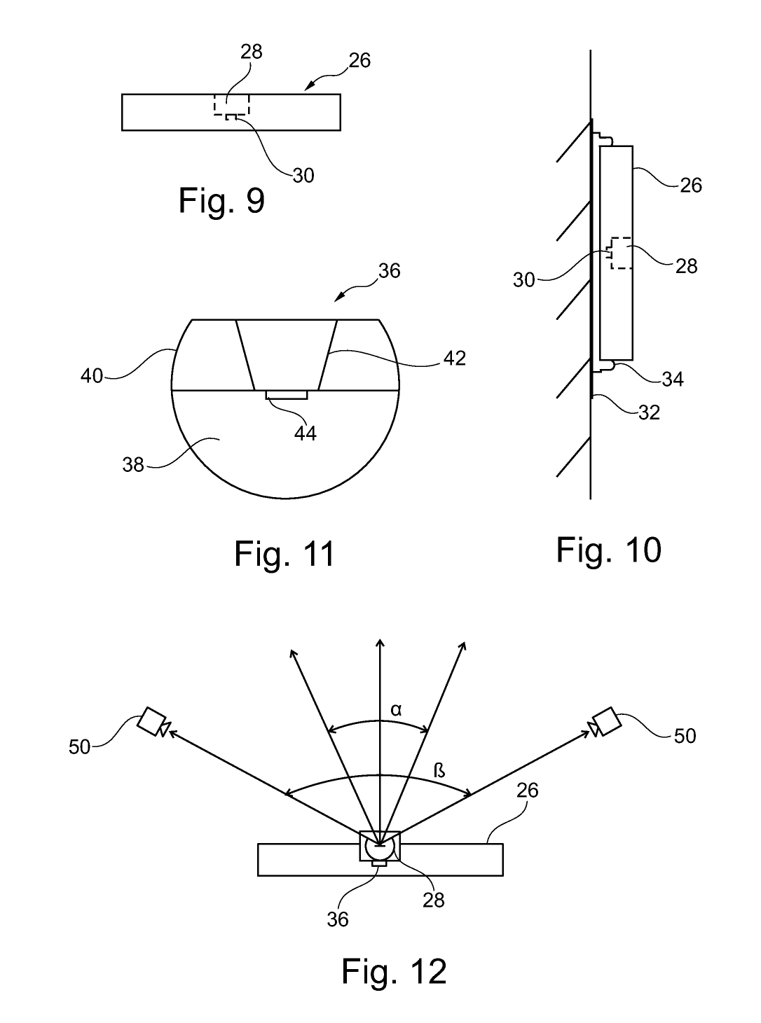

FIGS. 8 and 9 show such a combination marker 26, still without a retroreflector mark. A standard bore 28 and a magnet 30, arranged under the standard bore 28, are provided in the center of the marker 26. FIG. 10 shows a temporary attachment of such a combination marker 26 in a work environment by using a certified adhesive tape 32 and hot-melt adhesive 34.

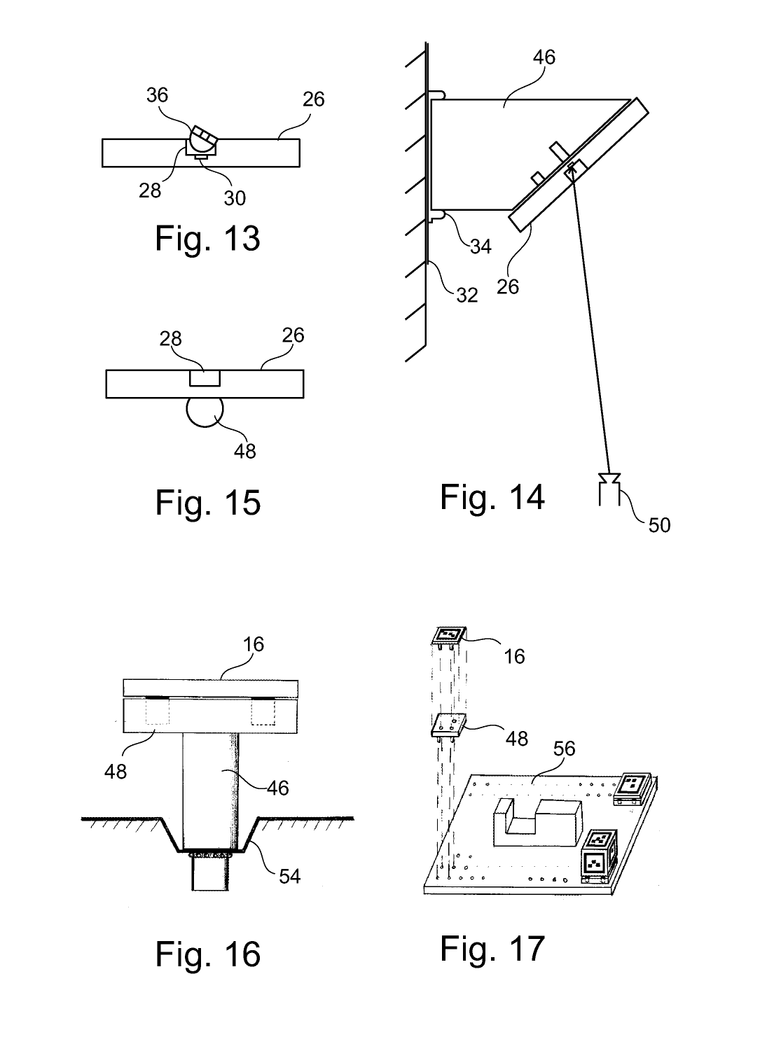

FIG. 11 shows a retroreflector mark 36 which is formed as a spherical element and can be plugged or clipped into the standard bore 28. The retroreflector mark 36 is composed of a metal hemisphere 38 and a spherical segment 40 which is screwed on and has a bore 42. The bore 42 exposes the center of the sphere. A retroreflector film 44 is fixed to the center. The viewing angle range a, related to the center of the sphere, for the laser projector (approx. 50 degrees) and the corresponding viewing angle range β for the camera 50 (approx. 120 degrees) of the visualization system are apparent from FIG. 12. To improve the viewing angle range for a particular position and/or orientation of the projection unit 14, the retroreflector mark 36 can be inclined, as is shown as an example in FIG. 13. An assembly using a suitable intermediate piece 46 or an adapter 48, in particular a plug-in adapter, can also contribute to an enhanced visibility of a combination marker 26, as shown in FIG. 14 and FIG. 15, respectively.

The dynamic referencing of the projection unit 14 requires that always at least four combination markers 26 be visible. For this purpose, a sufficient number of combination markers 26 with retroreflector marks 36 are reversibly fixed at specific positions in the work environment (here in the fuselage barrel 10), so that, if possible, the visibility of at least four positions is ensured for all intended perspectives of the projection unit 14.

Alternatively, the combination marker 26 may also be made such that the retroreflector mark 36 is laminated underneath the printed bit pattern 20 and is visible through a punching in the center of the bit pattern 20. The drawback is a poorer viewing angle; the advantage is a more cost-effective manufacture.

With the aid of the combination markers 26, the concept described allows the referencing of the laser projector in the projection unit 14 with the camera(s) 50 which are situated in the projection unit 14, i.e. within the same housing. This allows the laser projector to be tracked by the camera(s) at all times, and a manual aiming at the retroreflector marks after a repositioning is dispensable. The visualization, i.e. the transmission of the item of information, intended to be displayed, to the object can be directly adapted to the new position and/or orientation of the projection unit 14 by the camera tracking.

This solves the following problems: The projection unit 14 need no longer be mounted statically since the calibration is effected in real time. A flexible set-up/alteration/removal of the projection unit 14 is made possible. In the event the projection unit 14 is shifted, the projection is automatically converted correspondingly. In addition, any manual calibration upon set-up/alteration or shifting of the projection unit 14 is no longer necessary.

On the basis of the combination markers 26, an effective configuration of a self-registering laser projector can be designed using relatively simple means. It is sufficient to connect one single, inferior-quality, but very low-priced camera firmly with the laser projector of the projection unit 14. The quality of the information obtained from these camera pictures by means of image processing is, on its own, not sufficient to accomplish a precise registration of the self-registering laser projector with the environment. The information is sufficiently precise, however, for the laser beam to be able to detect the retroreflector marks 36 contained in the combination markers 26 with little search effort. The process may be summarized as follows: In a first step, the optical (black-and-white) properties (in particular the black border around the bit pattern 20) of a combination marker 26 are detected by the camera to determine the approximate direction of the laser beam. In a second step, the angle of the laser beam is varied by an automatic search method such that it comes to lie exactly on the retroreflector mark 36 of the combination marker 26. The advantage resides in that owing to the moderate accuracy requirement for accomplishing the first step, this system allows a construction at low cost and simple maintenance. In particular, any complicated calibration of the projection system and the camera is dispensed with. Nonetheless, a high-precision dynamic registration can be carried out in an automated manner in a very short time.

Returning to the exemplary scenario of fitting the mountings 12 in aircraft construction, according to this concept the actual work process for checking the fitting is as follows: The projection unit 14 is placed on a tripod 52 such that at least four combination markers 26 are in the viewing range of the camera(s) and of the projection unit 14. Based on the unique ID of the combination markers 26 as defined by the bit pattern 20, the visualization system can, at any time, match the pose of the individual markers 16 as detected in real time against the 3D positions determined in a setup phase in advance (calibration of the reference points). This allows the pose of the projection unit 14 in relation to the workpiece to be ascertained with sufficient accuracy to be able to successfully perform an automatic optimization by aiming at the retroreflector marks 36. The projection is started, and the first mounting 12 of a list to be checked is displayed. The projection marks the target contour of the mounting 12, so that an error in assembly can be identified immediately and without doubt (cf. FIGS. 3 and 4). All of the mountings 12 are checked one after the other in this way. In case a mounting 12 is not situated in the projection area of the projection unit 14, an arrow or some other information is displayed instead, and the projection unit 14 is repositioned accordingly. Checking can then be continued as described.

The system described assumes that the position and/or orientation of the retroreflector marks 36 in the coordinate system of the object is known. This may be achieved by plugging the retroreflector marks 36 and/or the combination markers 26 in at standard points or standard bores, possibly via special mechanical plug-in adapters 48 as shown in FIG. 15.

While the tracking with the aid of flat markers functions in real time, it is less accurate than the transformation calculated by the bearing of the retroreflector marks 36, depending on the quality of the camera(s) employed and the calibration method. But since, based on the flat marker tracking, the pose of the object relative to the projection unit 14 is sufficiently precisely known at all times, the automatic optimization (see above) can be initiated at any point in time and thus a highly accurate pose can be calculated within a few seconds. This is relevant in particular to quantitative measuring engineering applications (e.g., accurate bores in a workpiece).

An alternative configuration of the system which is likewise particularly advantageous functions without retroreflector marks. The requested projection accuracy is ensured here by the use of high-quality cameras, optical systems and calibration methods. Preferably, rather than one camera (mono), two cameras (stereo) are made use of. Using all of the markers 16 available in the viewing range, a precise pose can be calculated by a bundle block adjustment. In addition, the registration accuracy of the projection system is determined at any time in conjunction with this adjustment. This requires that more markers 16 are available than are necessary mathematically. Together with the accuracy of the offset between the camera(s) and the projection unit that is already known from the calibration of this offset, and the known intrinsic precision of the projection unit 14, this registration accuracy enters as an essential factor into the dynamically updated overall accuracy of the visualization system, of which the user can be informed at any time. This configuration has to be employed in connection with video projectors since a detection of retroreflector marks by laser projectors is not applicable here. Moreover, it offers the advantage of being able to react to dynamic motions or disturbances significantly faster.

By fixing a marker 16 or combination marker 26 in place not only at one, but at several points, it is not only possible to uniquely define the position of the center of the (combination) marker 16 or 26 in space (3 degrees of freedom), but also the orientation of the entire (combination) marker (6 degrees of freedom). This provides an advantage for the dynamic referencing of the self-registering laser projector since, rather than three, now only one (combination) marker is needed for the dynamic registration. While, in general, the registration accuracy is impaired thereby, there are special applications in which the accuracy is not of a superordinate importance in all dimensions.

Preferably, the system checks automatically whether the distribution of the (combination) markers in the viewing range is sufficient for a reliable adjustment along with a determination of an informative error residual and prevents any degenerated constellations (e.g., collinear markers, clustering of the markers in one part of the image). Likewise, depending on the application, stricter marker constellations with respect to quantity and distribution, i.e. exceeding the mathematically required minimum configuration, may be forced by the system in order to increase its reliability.

An example of such an application is welding of long, but narrow steel girders, for example H-girders, having the dimensions 10×0.3×0.3 m, to which struts are to be welded in accordance with static calculations. Here, special attention has to be given to the accuracy in the longitudinal direction of the girder. In such special cases, it may be sufficient to use only few (combination) markers 16 and/or 26, such as two in the example of the H-girder, which are placed at each of the ends thereof.

In the following, four different ways of fixing the markers 16 and combination markers 26 in place will be described:

(a) Fixing in place on an RPS borehole (see FIG. 16): In metal-working, e.g. in the automotive industry, so-called reference point system holes (RPS holes) 54 are frequently used, which are produced with high precision and serve, inter alia, to receive robot-controlled grippers. Their precision makes these RPS boreholes 54 suitable for use as reference points for attaching markers 16 and/or combination markers 26. To allow the RPS holes 54 to be made use of for fixing, special holders are incorporated in the (combination) markers 16 and/or 26, so that they can be clipped in reproducibly in all possible positions (one clipping point) or poses (at least two clipping points), that is, not only in positions/poses in which they are held by gravity. Magnets (which may also be incorporated in an intermediate piece 46 or an adapter 48), special clamping feet similar to a “banana plug”, or screws may serve as holders.

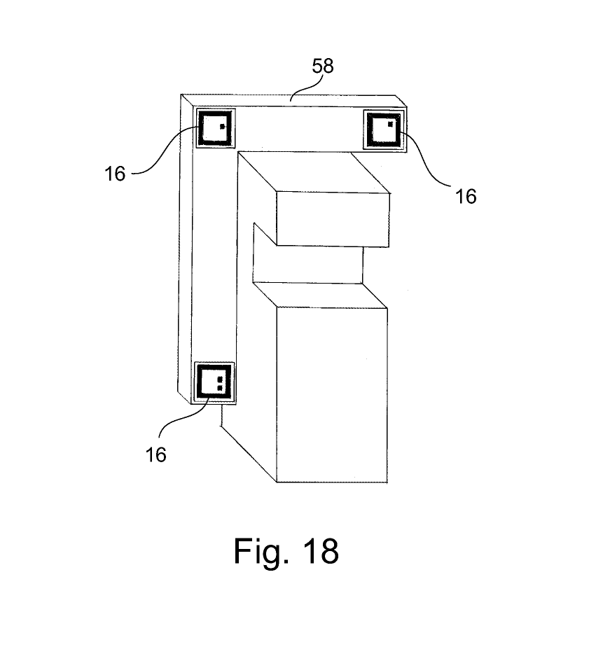

(b) Fixing in place on a perforated plate (see FIG. 17): Frequently, components are processed on standardized perforated plates having a fixed and known hole matrix, e.g. in prototype construction in the automotive industry. The component is firmly anchored on this perforated plate 56 during the work process and is spatially registered with it. The perforated plate 56 provides an excellent way of attaching generically shaped (combination) markers 16 and/or 26 quickly, intuitively and reproducibly. Since the component and the perforated plate 56 are already registered, the pose of the (combination) markers 16 and/or 26 can be specified in the object coordinate system of the component without much additional effort. The system just has to be informed of the positions of the matrix at which the (combination) marker(s) 16 and/or 26 was/were clipped in.

(c) Fixing in place on a surface of the object (virtual gauge; see FIG. 18): The variants described sub (a) and (b) for fixing in place are based on individual (combination) markers 16 and/or 26 which, specifically, are generic and may be employed in the form of “building blocks” for a large variety of purposes. By contrast, the variant referred to as a “virtual gauge” here is characterized by a skillful adaptation of a constellation of (combination) markers 16 and/or 26 to a specific application. The virtual gauge can be illustrated using the example of a bracket 58 as is utilized in woodworking, stone- and metal-working and in the building trade to transfer the right angles typically required in its application to a workpiece in a simple manner. An exemplary configuration of the virtual gauge is a three-marker configuration of (combination) markers 16 and/or 26 on such a bracket 58. The virtual gauge is especially suitable for applications in which digital information needs to be projected onto a flat surface, e.g. in the installation of anchoring elements on a hall floor in plant construction. There are as many conceivable configurations as there are workpieces. The advantage of the virtual gauge resides in that it can be used intuitively and, more particularly, can also be applied in a reproducible fashion to such workpieces which do not have RPS holes (see (a)) and/or which have surfaces with very complex shapes, e.g. curvatures. Ideally, the virtual gauge is already included by design into the CAD model of the workpiece (by analogy with the RPS holes, which in fact are also already present in the CAD model). For the production of the virtual gauges, rapid prototyping (3D printers) may be made use of, which provide a sufficient accuracy and allow manufacturing at low cost. A special configuration may be referred to as a complex virtual 3D gauge: Some situations do not allow the use of a generic virtual gauge because the work object does not offer any repetitive connecting points (such as right angles). In such cases, the gauges are uniquely adapted to the 3D surface of the work object. The gauges then constitute the exact 3D counterpart (negative) of the work object. Such gauges may be fitted using one of the types of fixing described sub (a), e.g. with the aid of magnets.

(d) A combination of a virtual gauge and RPS holes 54 is also possible, in which the virtual gauge is optimized towards a specific, frequently recurring constellation of RPS holes 54. Compared with the generic RPS (combination) markers 16 and/or 26 (see (a)), a simplified handling can be achieved, with any potential sources of errors being eliminated as well. For instance, in the case of a multitude of identical RPS holes on a workpiece into which a small amount of (combination) markers 16 and/or 26 are to be clipped, some occasional (combination) markers 16 and/or 26 might be inadvertently clipped into an incorrect hole 54. At best, this results in the user being confused; at worst, in production errors which remain undiscovered for the time being. A specially designed virtual gauge, on the other hand, can be manufactured such that all ambiguities are eliminated (Poka-Yoke principle).

As already mentioned above, special adapters 48 may also be used for fixing the markers 16 and/or combination markers 26 in place. Various generic (combination) markers 16 and/or 26 may be fastened on the adapters 48. The adapters 48 and the (combination) markers 16 and/or 26 are formed such that they can be uniquely plugged into one another. The (combination) markers 16 and/or 26 and the adapters 48 always relate to the same coordinate system. It is therefore no longer required to further calibrate the (combination) markers 16 and/or 26 and the adapters 48 in relation to each other because the system immediately recognizes the new coordinate system of the (combination) marker 16 or 26 from the combination of the (combination) markers 16 and/or 26 and the adapters 48.

Oftentimes no reference points (standard points or standard bores) are available on the workpiece or in the work environment. In this case, classical measuring technology may be employed to calibrate the (combination) markers 16 and/or 26 in the environment. To this end, provision may be made that a probe sphere is attached to a fitted (combination) marker 26, the probe sphere being adapted to be detected by a tactile measuring system. In particular, such a probe sphere may be placed in the center of a combination marker 26 to determine the center of gravity of the flat marker part and of the retroreflector mark 36. The retroreflector mark 36 can be removed for this purpose since it is held only by the magnet 30. It is thus possible to selectively clip in the probe sphere of the tactile measuring system or the retroreflector mark 36 of the tracking device.

Alternatively, the fitted (combination) markers 16 and/or 26 may also have specific markers attached thereto which are used in common photogrammetric measuring systems in industry. Such—e.g. round—standard marks may be attached in particular in the corners of the quadrangular (combination) markers 16 and/or 26, more precisely on the outer white border 22. This method or comparable methods are based on bundle block adjustment, with photos being used for obtaining the registration of the (combination) markers 16 and/or 26 in relation to one another.

According to an alternative approach, the visualization system presented may be realized on the basis of structured light scanning technology, entirely without any markers or (combination) markers. Structured light scanning systems, also known as “structured light 3D scanners” in English language usage, are already in use nowadays to generate so-called “dense point clouds” of objects, a classical method of measuring technology. Depending on the size of the objects to be measured, structured light scanners or laser scanners are employed. The former ones function based on structured light projection, the latter ones based on a projection of laser lines, combined with the measurement of the travel time of the light (time of flight). In spite of different physical measuring principles, the result in each case is a dense point cloud which represents the surface of the scanned object. These point clouds (sometimes several million points) may now be transferred in terms of software engineering to an efficiently manageable polygon mesh by surface reconstruction (triangulated irregular network). A further algorithmic transformation step permits the reconstruction into a CAD model, in particular with so-called NURBS surfaces (non-uniform rational B-spline). This technology is currently mainly utilized for the applications of reverse engineering and quality assurance (matching a scanned surface against a planned surface in the context of a variance comparison).

The projection unit 14 can be used for carrying out such a structured light scanning process on a workpiece for the purpose of tracking (determination of translation/rotation). In the process, the laser projector or video projector projects an image which is optically detected by the camera(s) and then triangulated or reconstructed in 3D. Therefore, markers may be dispensed with and, instead, applying a useful systematic process, points on the workpiece are scanned and utilized for calculating the pose by an iterative best fit strategy. This form of tracking does not require a dense point cloud; it may be considerably thinner, which significantly shortens the computing time. The advantage of using the structured light scanning technology for the tracking is that no preparation at all of the workpiece, such as an attachment of the markers, is necessary.

The visualization system described by way of example can also be utilized in other applications, e.g. in the drilling and inspection of holes. In doing so, the desired position of the drill and its diameter are projected as an information. The visualization system may also be employed in quality assurance on the assembly line, in particular in the automotive industry. Instead of the flexible repositioning of the projection unit in a large, stationary object, here the object itself moves. On the basis of statistical methods, areas to be inspected by random sampling (e.g. weld spots) are marked. The projected information moves along with the movement of the object on the conveyor belt. A further application is maintenance in a garage or shop. The mobile projection unit, possibly fastened to a swivel arm, is purposefully made use of to project mounting instructions onto an object in tricky situations. The system may also be utilized for visualizing maintenance instructions to local servicing staff from an expert who is not locally available (remote maintenance).

Although an embodiment of this invention has been disclosed, a worker of ordinary skill in this art would recognize that certain modifications would come within the scope of this disclosure. For that reason, the following claims should be studied to determine the true scope and content of this disclosure.

1. A system for visually displaying information on real objects, comprising:
a projection unit that graphically or pictorially transmits an item of information to an objects;
a dynamic tracking device having a 3D sensor system that determines and keeps track of a position and/or orientation of the object and/or of the projection unit in space; and
a control device for the projection unit which adapts a transmission of the item of information to a current position and/or orientation of the object and/or of the projection unit as determined by the dynamic tracking device.

2. The system according to claim 1, wherein the dynamic tracking device is designed for a continuous detection of the position and/or orientation of the object and/or of the projection unit in real time.

3. The system according to claim 1, wherein a projector and the 3D sensor system of the dynamic tracking device are accommodated in the projection unit, the projection unit being an apparatus for mobile installation.

4. The system according to claim 1, wherein the 3D sensor system of the tracking device includes at least one camera which is connected with a projector of the projection unit.

5. The system according to claim 1, wherein are arranged at reference points of an environment in which the system is employed, and which are adapted to be detected by the 3D sensor system of the dynamic tracking device.

6. The system according to claim 5, wherein the markers and the dynamic tracking device are adjusted to each other such that by using the markers, the tracking device can perform a calibration of the reference points in a coordinate system of the environment or of the object, and can perform the determination and keeping track of the position and/or orientation of the object and/or of the projection unit.

7. The system according to claim 5, wherein the markers are based on flat markers and preferably include characteristic shapes.

8. The system according to claim 5, wherein the markers include unique identification features adapted to be detected by the dynamic tracking device.

9. The system according to claim 5, wherein the markers include retroreflector marks.

10. The system according to claim 9, wherein the retroreflector marks are spherical elements having an opening through which a retroreflector film is visible which is preferably fixed to the center of a sphere.

11. The system according to claim 5, wherein the markers are configured such that the markers adapted to be fixed, in the environment in which the system is employed, to reference points having a known or reliable position in a coordinate system of the environment or of the object, in particular by being fitted into RPS holes provided at the reference points, holes of a perforated plate with a fixed and known hole matrix, and/or on a surface of the object.

12. The system according to claim 5, wherein at least one marker is fixed in place at several points in order to also define an orientation of the marker in space.

13. The system according to claim 5, wherein the markers are configured such that the markers are adapted to be fixed, via adapters or intermediate pieces, to reference points having a known or reliable position in a coordinate system of the environment or of the object, in particular by being fitted into RPS holes provided at the reference points, holes of a perforated plate with a fixed and known hole matrix and/or on a surface of the object, the adapters and the markers being adjusted to each other such that the markers can be uniquely plugged into the adapters.

14. The system according to claim 5, wherein the markers include a standard bore and a magnet arranged under the standard bore.

15. The system according to claim 1, wherein the projection unit and the dynamic tracking device are designed such that structured light scanning technology is used to determine the position and/or orientation of the object.

16. A method of visually displaying information on real objects using a projection unit, comprising the steps of:
determining a current position and/or orientation of the object and/or of the projection unit in space;
graphically or pictorially transmitting an item of information to the object on the basis of the position and/or orientation as determined;
detecting and determining a change in the position and/or orientation of the object and/or of the projection unit; and
adapting the transmission of the item of information to the changed position and/or orientation of the object and/or of the projection unit.

17. The method according to claim 16, wherein the current position and/or orientation of the object and/or of the projection unit is continuously detected in real time.

18. The method according to claim 16, wherein a laser projector of the projection unit is utilized to aim at markers which are arranged at reference points of an environment in which the method is employed, the markers being detected by a 3D sensor system of a tracking device.

19. The method according to claim 18, wherein the markers are used for a calibration of the reference points in a coordinate system of the environment or of the object and for the determination of a change in the position and/or orientation of the object and/or of the projection unit.

20. The method according to claim 16, wherein detection and determination of a change in the position and/or orientation of the object and/or of the projection unit is based on an inside-out type tracking method using at least one movable camera and fixedly installed markers.

21. The method according to claim 16, wherein to determine the position and/or orientation of the object, a structured light scanning process is carried out in which preferably the projection unit projects an image which is captured using one or more cameras and is subsequently triangulated or reconstructed, with points on the object being further scanned preferably in accordance with a predefined systematic process, and an iterative best fit strategy is utilized to calculate the position and/or orientation of the object.

22. The method according to claim 16, wherein current accuracy of a visual display is ascertained at any time with the aid of a dynamic tracking device which performs detection and determination of a change in the position and/or orientation of the object and/or of the projection unit.
